(19) United States
(12) Patent Application Publication
(10) Pub. No.: US 2019/0268601 A1
(43) Pub. Date: Aug. 29, 2019

(54) EFFICIENT STREAMING VIDEO FOR STATIC VIDEO CONTENT

(71) Applicant: Microsoft Technology Licensing, LLC, Redmond, WA (US)

(72) Inventors: Mei-Hsuan Lu, Bellevue, WA (US); Ming-Chieh Lee, Bellevue, WA (US); Siddharth Deepak Mehta, Kirkland, WA (US)

(73) Assignee: Microsoft Technology Licensing, LLC, Redmond, WA (US)

(21) Appl. No.: 15/905,444

(22) Filed: Feb. 26, 2018

(51) Int. Cl. H04N 19/159; H04N 19/136; H04N 19/70

(52) U.S. Cl. CPC H04N 19/159; H04N 19/70; H04N 19/136

(57) ABSTRACT

Techniques are described for streaming video content between computing devices. For example, a computing device can stream encoded video content to one or more receiving devices. The computing device can detect whether video content to be encoded is static content or dynamic content and switch the coding structure accordingly. For example, if the video content is determined to be static video content, then the static content can be encoded using a first predictive coding structure in which the first video frame is encoded as a single key frame and subsequent video frames are encoded as predicted frames that are non-reference frames and that only reference the single key frame. If the video content is determined to be dynamic video content, then the dynamic content can be encoded using a second predictive coding structure different from the first predictive coding structure.

### BACKGROUND

Streaming video involves two or more users that stream video content to one another. One type of streaming video is a video call in which a user's computing device captures the user's image and transmits it, as a continuous stream of video frames, to a receiving device. Another type of streaming video is desktop sharing which a user's computer desktop is captured and continuously transmitted, as a sequence of video frames, to a receiving device.

Streaming video is transmitted between two or more devices via a computer network, such as the Internet. Because network problems can occur on the computer network (e.g., lost or corrupted network packets), streaming video technologies are designed to handle such problems. For example, when video frames are lost or corrupted, the receiving device can wait for a new key frame to resume decoding. With some solutions, the receiving device can send a message to the sending device to generate a new key frame from which the receiving device can resume decoding.

While such solutions may operate efficiently for some types of video content (e.g., dynamic video content in which the content changes significantly from frame to frame), they suffer from a number of problems. For example, the inability to decode video frames for a period of time after a network loss occurs can result in stalled and/or corrupted playback of the video content at the receiving device. In addition, if the receiving device has to generate and send a request to the sending device to transmit a new key frame, the result is an increase in latency while the receiver waits for the new key frame.

Therefore, there exists ample opportunity for improvement in technologies related to streaming video.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Technologies are described for streaming video content between computing devices. For example, a computing device can stream encoded video content to one or more receiving devices. The computing device can detect whether video content to be transmitted is static content or dynamic content. Depending on whether the content is static content or dynamic content, the coding structure used to encode the content can be switched. For example, if the video content is determined to be static video content, then the static video content can be encoded using a first predictive coding structure in which the first video frame is encoded as a single key frame and subsequent video frames are encoded as predicted frames that are non-reference frames and that only reference the single key frame. If the video content is determined to be dynamic video content, then the dynamic video content can be encoded using a second predictive coding structure different from the first predictive coding structure.

For example, a method can be provided for streaming video content. The method comprises detecting whether video content to be transmitted is static content or dynamic content. Upon determining that the video content is static content, static content is encoded according to a first predictive coding structure, which comprises encoding a first video frame of the static content as a single key frame, and encoding all subsequent video frames of the static content as predicted frames, where the predicted frames are non-reference frames that only reference the single key frame for decoding. The encoded first video frame and the encoded subsequent video frames of the static content are transmitted as they are encoded (e.g., as a real-time video stream) to one or more other computing devices.

As another example, a method can be provided for streaming video content, including switching a predictive coding structure between static content and dynamic content. The method comprises detecting whether video content to be transmitted as a real-time video stream is static content or dynamic content. Upon determining that the video content is static content, the static content is encoded according to a first predictive coding structure, which comprises encoding a first video frame of the static content as a single key frame, and encoding all subsequent video frames of the static content as predicted frames, where the predicted frames are non-reference frames that only reference the single key frame for decoding. The encoded first video frame and the encoded subsequent video frames of the static content are transmitted as they are encoded to one or more other computing devices as the real-time video stream

As another example, upon determining that the video content has switched form static content to dynamic content, the dynamic content can be encoded and transmitted according to a second predictive coding structure in which at least some of the predicted video frames of the dynamic content are permitted to be reference frames.

As described herein, a variety of other features and advantages can be incorporated into the technologies as desired.

### BRIEF DESCRIPTION OF THE DRAWINGS

FIG. 1 is a diagram depicting an example environment for streaming video content, including detecting video content type.

FIG. 2 is a diagram depicting example predictive coding structures.

FIG. 3 is a flowchart of an example method for streaming video content, including using a first predictive coding structure for static content.

FIG. 4 is a flowchart of an example method for streaming video content, including switching between predictive coding structures depending on whether video content is static content or dynamic content.

FIG. 5 is a flowchart of an example method for detecting a type of video content and switching between predictive coding structures.

FIG. 6 is a diagram of an example computing system in which some described embodiments can be implemented.

FIG. 7 is an example mobile device that can be used in conjunction with the technologies described herein.

FIG. 8 is an example cloud-support environment that can be used in conjunction with the technologies described herein.

### DETAILED DESCRIPTION

Overview

As described herein, various techniques and solutions can be applied for streaming video content (also called video sharing) between computing devices. For example, a computing device can stream encoded video content to one or more receiving devices. The computing device can detect whether video content to be transmitted is static content or dynamic content. Depending on whether the content is static content or dynamic content, the coding structure used to encode the content can be switched. For example, if the video content is determined to be static video content, then the static video content can be encoded using a first predictive coding structure in which the first video frame is encoded as a single key frame and subsequent video frames are encoded as predicted frames that are non-reference frames and that only reference the single key frame. If the video content is determined to be dynamic video content, then the dynamic video content can be encoded using a second predictive coding structure different from the first predictive coding structure. For example, in the second predictive coding structure, predicted frames can be reference frames and/or multiple key frames can be used (e.g., transmitted on a periodic basis).

Video streaming occurs when a sending device encodes video content and transmits the encoded video content as a stream of video frames, as streaming video, to one or more receiving devices for decoding and display. One type of streaming video is a video call (e.g., a video conference call) in which a computing device captures video content from a camera, encodes the video content, and transmits the encoded video content to one or more other computing devices. The video call can be a two-way call in which the other computing devices are also transmitting encoded video content captured from their cameras. Another type of streaming video involves sharing of a computer desktop. For example, one user could share their graphical computer desktop (including application windows, icons, graphics, images, etc.) with another user. The desktop can be shared as the user manipulates the desktop content (e.g., as a real-time video stream). Another type of streaming video involves sharing of digital content, which can include pictures, images, graphics, videos, etc. For example, a user could share a digital image of a diagram or schematic. As another example, a user could share a digital photo. Regardless of the type of video content that is being shared, the sending device encodes the video content as a sequence of video frames that are transmitted to one or more receiving devices as streaming video.

Video streaming (e.g., video calls, desktop sharing, etc.) is sensitive to network conditions, and problems can occur when network issues are encountered. In typical streaming video solutions, video frames are created using a coding structure in which key frames are generated periodically and in which predicted frames can rely on other predicted frames. However, Use of such coding structures can be problematic when network issues occur. For example, if network loss is encountered during a streaming video session, then video frames can be lost or corrupted. If a reference video frame is lost or corrupted, then the receiving device may be unable to continue decoding the video stream, which can result in a pause in video playback, or may be unable to correctly decode the video stream, which can result in corrupted video. In some situations, the receiving device may be able to continue decoding if a new decodable frame is received after a period of time (e.g., a new I frame or other type of independently decodable frame). In some situations, the receiving device transmits a request to the sending device to transmit a new key frame (sometimes called a sync frame, which in some implementations is an instantaneous decoder refresh (IDR) frame) from which the receiving device can resume decoding.

However, using such solutions (e.g., periodically transmitting key frames and/or transmitting new sync frames) still results in reduced efficiency. For example, such solutions increase network bandwidth and computing resource utilization. For example, computing resources and network resource utilization are increased when the sending device has to create additional key frames (which are typically larger in size) and when the receiving device has to request a new key frame. In addition, such solutions result in an increase in network latency. For example, if a receiving device has to wait for a new key frame or transmit a sync request for a new key frame, then latency will be increased.

In the technologies described herein, the efficiency of streaming video is improved by changing the predictive coding structure so that a special predictive coding structure is used when static content is being shared. Upon detecting that static content is being shared (e.g., a computer desktop with little change between frames, or a static drawing or picture), the predictive coding structure used to encode the video content can be switched to the special predictive coding structure so that the first video frame of the static content is encoded as a key frame (e.g., as an IDR frame). The subsequent video frames are then encoded as non-reference frames that reference the key frame (e.g., the subsequent video frames are predicted “P” frames that reference only the key frame). Using the special predictive coding structure, there will be only one key frame, which is the first video frame of the static content, and the subsequent frames of the static content after the key frame will be non-reference predicted frames that only reference the key frame for decoding (i.e., the subsequent frames will not contain key frames).

Using the special predictive coding structure for static content improves efficiency of the video streaming process. For example, static content can be encoded using a single key frame (e.g., a single IDR frame) as the first frame. Then, all subsequent video frames of the static content can be encoded as predicted frames that only reference the single key frame. Because the subsequent video frames are non-reference frames (i.e., the subsequent video frames cannot act as a reference frame), there is no dependence between the subsequent video frames. As a result of this special predictive coding structure, the receiving device can continue decoding subsequent video frames even if a network problem causes some of the subsequent video frames to be lost or corrupted. For example, instead of sending a request for a new IDR frame when a network loss occurs (which requires additional computing and network resources, and increases latency), the receiving device can just continue decoding the subsequent video frames when they are received as they all reference the single key frame.

The technologies described herein also provide advantages in terms of backward compatibility. For example, consider video stream receiver that is configured to send a sync request (e.g., a request for a new IDR frame) upon losing a reference frame that is needed for decoding (e.g., an I frame or P frame that is relied upon as a reference frame for one or more subsequent frames). However, if the receiver is only receiving subsequent video frames that are non-reference frames and that only reference a first key frame, then the receiver will not need to send a sync request (e.g., the receiver can continue decoding when new subsequent video frames are received because they will not depend on any lost or corrupted subsequent video frames). Therefore, the receiver does not need to be modified to take advantage of the technologies described herein.

### Video Content

In the technologies described herein, video content is encoded to create encoded video content (encoded according to one or more video coding standards). In order to create the encoded video content, the video content is obtained (e.g., captured from a camera, obtained from computer desktop, obtained from a computer file, etc.) and the frames (also called pictures) of the video content are encoded according to one or more video coding standards producing corresponding frames of encoded video content, which can be called an encoded video stream. For example, an encoded video stream can be encoded according to the MPEG-1/MPEG-2 coding standard, the SMPTE VC-1 coding standard, the H.264/AVC coding standard, the H.265/HEVC coding standard, or according to another video coding standard.

Encoded video content can be stored, transmitted, or received in a digital container format. The digital container format can group one or more encoded video streams and/or one or more encoded audio streams. The digital container format can also comprise meta-data (e.g., describing the different video and audio streams). Examples of digital container formats include MP4 (defined by the MPEG-4 standard), AVI (defined by Microsoft®), MKV (the open standard Matroska Multimedia Container format), MPEG-2 Transport Stream/Program Stream, and ASF (advanced streaming file format).

### Environment for Video Streaming of Static Content

In the technologies described herein, video content can be streamed as a continuous stream of encoded video frames between computing devices (e.g., senders and receivers). For example, a sending device can obtain and encode video content and stream the encoded video frames to one or more receiving devices (e.g., as a live real-time video stream).

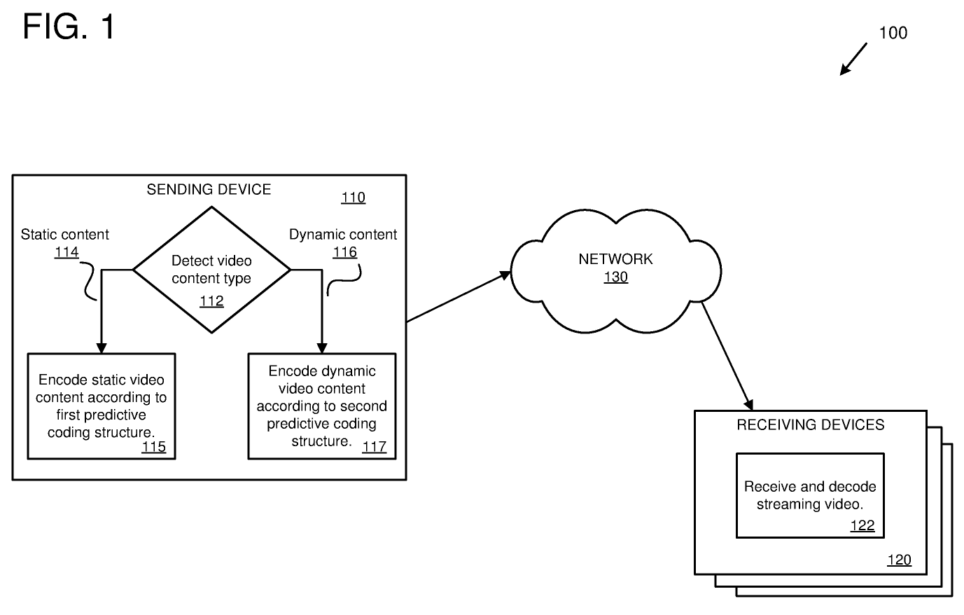

FIG. 1 is a diagram depicting an example environment 100 for streaming video content, including detecting video content type. The environment 100 includes a sending device 110. The sending device 110 can be any type of computing device (e.g., a smart phone, desktop, laptop, tablet, gaming console, or another type of computing device). The sending device 110 streams encoded video content as a sequence of video frames to one or more receiving devices 120 via a network 130. For example, the network 130 can include various types of local area networks and/or wide area networks (e.g., comprising the Internet). The receiving devices 120 can be any type of computing devices (e.g., smart phones, desktops, laptops, tablets, gaming consoles, or other types of computing devices).

The sending device 110 obtains video content (e.g., from a camera, from a desktop, from a file, etc.) and detects the type of the video content, as depicted at 112. When the video content is static content, as depicted at 114, the static video content is encoded according to a first predictive coding structure, as depicted at 115. The first predictive coding structure is the special predictive coding structure described herein in which the first video frame of the static video content is encoded as a single key frame and all of the subsequent video frames of the static video content are encoded as non-reference predicted frames that only reference the single key frame. When the video content is dynamic video content, as depicted at 116, the dynamic video content is encoded according to a second predictive coding structure, as depicted at 117. The second predictive coding structure is a coding structure different from the first predictive structure. For example, the second predictive coding structure can be a coding structure that uses multiple key frames (e.g., I frames or IDR frames that are encoded on a periodic basis). The second predictive coding structure can also be a coding structure that permits predicted video frames to rely on other predicted video frames (e.g., P frames or B frames can be used as reference pictures).

The sending device 110 encodes and transmits encoded video content on a continuous basis as a sequence of video frames (e.g., as a video stream) to the receiving devices 120. The receiving devices 120 receive and decode the encoded video frames of the streaming video, as depicted at 122. The receiving devices can display the decoded video frames (e.g., on a local or remote display).

The sending device 110 and receiving devices 120 can comprise hardware and/or software resources to perform the described operations. For example, video encoding and/or decoding software can implement the video encoding and/or decoding operations.

The sending device 110 can switch between the predictive coding structures as needed. For example, the sending device 110 can continuously detect the video content type, as depicted as 112, and switch when a different type is detected. For example, a user of the sending device 110 could be sharing a desktop with the receiving devices 120. During a first time period, the desktop could be displaying static content (e.g., with no change to the desktop or with only small changes such as cursor movement) which is detected and encoded according to the first predictive coding structure. Later, during a second time period, the user could initiate display of dynamic content within the shared desktop, such as launching an application or displaying a video. The switch to the dynamic content can be detected and the coding mode can be switched to the second predictive coding structure. Later, during a third time period, the user could initiate display of an image file depicting a schematic (e.g., a JPEG image), which can be detected as static content and encoded according to the first predictive coding structure as a sequence of video frames and transmitted as streaming video. Switching can occur, back-and-forth, as the video content switches between static and dynamic content.

By maintaining a continuous stream of video frames for static video content that may not change from one frame to the next (e.g., there could be no change if the video content is a picture or image file), certain benefits can be realized. For example, some technologies rely on the telemetry generated during video streaming to ensure that the stream is still operating correctly (e.g., that the network connection is still active). Without a continuous stream of video frames, the receiving device may have no way to tell if a network problem has occurred. In addition, streaming video can be performed on a continuous basis even when video content switches between static content and dynamic content.

Various techniques can be used to determine whether video content is static content or dynamic content. In some implementations, the determination is made based on a selection of the video content. For example, if the user selects a digital image or picture (e.g., a computer file containing a digital image, such as a diagram or schematic), then the video content can be determined to be static content (e.g., as long as the digital image or picture is being shared). Selection of a digital image or picture could occur during a video streaming session. For example, a user could initiate a video streaming session as a video call in which live video of the user is captured via a camera and encoded and streamed as dynamic video content. Later, the user could switch from displaying the live captured video to displaying a digital image, which can be detected as static content and encoded and streamed as static content.

In some implementations, the determination of whether video content is static content or dynamic content is made based on detecting changes in the content of video frames. For example, if there is no change, or little change, to the content of two or more consecutive video frames, then the video content can be determined to be static content. In some implementations, the amount of change is calculated based on the difference in pixel values (e.g., RGB or YUV pixel values) between the video frames and comparing the difference to a threshold value. If the difference is less than the threshold value, then the content can be determined to be static content, and otherwise the content can be determined to be dynamic content. In some implementations, the difference between video frames is calculated using a sum of absolute differences (SAD) measure to evaluate the similarly between the video frames (e.g., between corresponding portions of the video frames, such as blocks or macroblocks).

In some implementations, the decision to switch from static content to dynamic content, or from dynamic content to static content, is made only after observing a change in the type of video content over a period of time. For example, video content that is currently determined to be static video content (and encoded and streamed as static video content) can continue to be classified as static video content until the content type is determined to have changed for a period of time (e.g., for a number of seconds, such as 10 seconds). By maintaining the content type of the video content for a period of time, short-term fluctuations to the encoding mode can be avoided which can improve efficiency (e.g., where a brief period of dynamic content occurs within video content that is otherwise static). This technique can help minimize expensive changes (e.g., in terms of computing and network resources) to the encoding mode (e.g., switching between a first predictive coding structure and a second predictive coding structure). As an example, if a user is streaming video of a slide presentation, then the slide presentation video can be encoded as static content even though there may be occasional transitions from one slide to the next.

In some implementations, a combination of approaches is used to determine whether video content is static content or dynamic content.

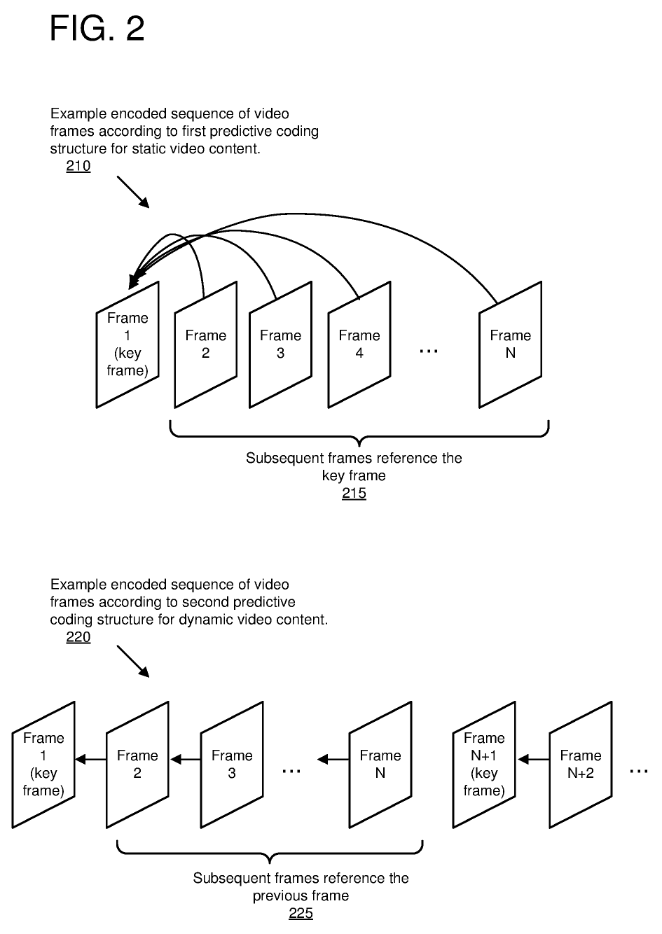

FIG. 2 is a diagram depicting example predictive coding structures. A predictive coding structure defines the types of frames that are created and the dependence between the frames. The predictive coding structure depicted at 210 is the special predictive coding structure used for static video content. With the special predictive coding structure, the first video frame is encoded as a single key frame and all of the subsequent video frames of the static content are encoded as predicted frames that are non-reference frames and that only reference the single key frame. As depicted at 210, the single key frame is labeled “frame 1” and is encoded as the first frame of the static video content. The subsequent frames of the static video content, labeled frame 2 through frame N and depicted at 215, are encoded as non-reference frames (e.g., non-reference P frames) that reference frame 1 (the key frame). As illustrated, with the special predictive coding structure, any number of subsequent frames can be encoded for the same static content, and they are all non-reference frames that reference only frame 1. Also, there are no other key frames after frame 1 for the same static content. However, if the video content switches to dynamic content and then back to static content, then the new static content will being again with a single key frame and subsequent non-reference predicted frames, as depicted at 210, for as long as the new static content is being streamed or until another switch occurs to a different predictive coding structure (e.g., a switch to dynamic content).

As the special predictive coding structure depicted at 210 illustrates, only one key frame (e.g., an IDR frame) is encoded at the beginning of the static video content. Following the single key frame, any number of subsequent video frames can be encoded, as depicted at 215. The loss of one or more of the subsequent video frames will not affect the ability of the recipient to continue decoding with the next received frame. For example, if frame 3 is lost, then decoding can continue with frame 4 because frame 4 only references the key frame and there is no reliance on frame 3. Furthermore, decoding can continue without the receiver having to send a request for a new key frame (e.g., a sync request is not needed) because frame 4 can be decoded using the already received key frame (frame 1). This arrangement reduces latency as a round-trip is not needed to request a new key frame.

Furthermore, use of the special predictive coding structure depicted at 210 suppresses key frame (e.g., IDR frame) insertion in certain video streaming situations. For example, with some existing loss handling technologies, the receiver will send a request for a new key frame (e.g., a sync request) when the receiver experiences frame loss or frame corruption and cannot continue decoding. The request for a new key frame involves the sender receiving the request, generating a new key frame, and sending the new key frame to the receiver which allows the receiver to restart the decoding process. When using the special predictive coding structure depicted at 210, frame loss or corruption will not result in a request for a new key frame and therefore key frame insertion by the sender is not needed.

In some implementations, the video content is encoded according to the H.264 video coding specification. When the special predictive coding structure is used, all of the subsequent video frames are encoded with a nal_ref_idc syntax element value of zero, which specifies that the subsequent video frames cannot be used as reference frames. Other video coding specifications can also be used to encode the video content, and syntax elements, flags, parameters, and/or other types of settings can be used to indicate that the subsequent video frames cannot be reference frames (e.g., a picture that is marked as “unused for reference” according to the H.265 video coding specification).

The predictive coding structure depicted at 220 is an example of a predictive coding structure that can be used for dynamic video content. As depicted at 220, the predictive coding structure begins with frame 1, which is a key frame. After frame 1 there are a number of subsequent predicted frames (e.g., P frames) that reference the previous frame, as depicted at 225. For example, frame 2 references frame 1, frame 3 references frame 2, and so on. Following the sequence of predicted frames is another key frame N+1, and following the key frame N+1 is another sequence of predicted frames.

### Methods for Streaming Static Video Content

In any of the examples herein, methods can be provided for streaming video content that includes using different coding structures depending on whether the video content is static video content. For example, when static video content is detected, the coding structure can be changed to a special predictive coding structure in which the first video frame is encoded as a single key frame and subsequent video frames are encoded as predicted frames that are non-reference frames and that only reference the single key frame.

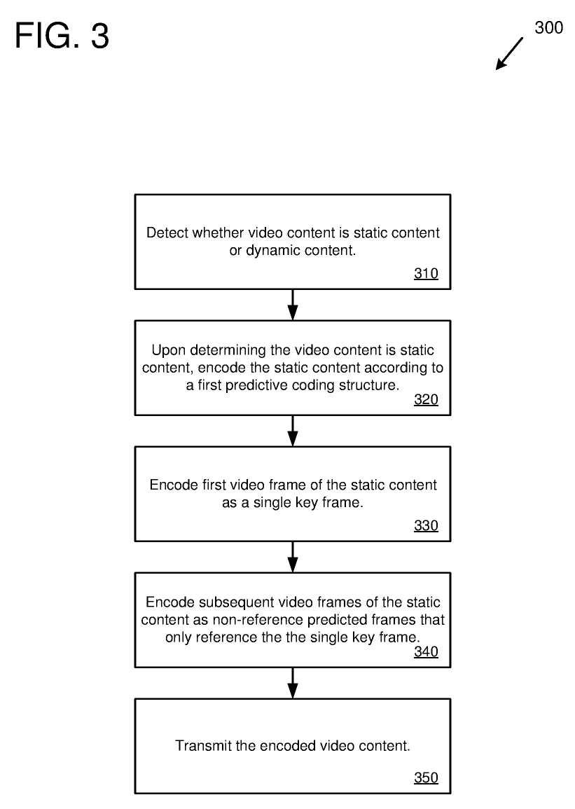

FIG. 3 is a flowchart of an example method 300 for streaming video content (e.g., as a video conference, a shared desktop, a shared video of a digital image, etc.). The example method 300 can be performed, at least in part, by a computing device, such as sending device 110. The example method 300 is performed during video streaming, such as a video call or desktop sharing session, during which video content is obtained (e.g., from a camera, from a computer desktop, from a file, etc.) and video frames are encoded and transmitted on a continuous basis for a period of time. In some implementations, the streaming video is encoded and transmitted as a real-time video stream.

At 310, the type of video content is detected as either static content or dynamic content. For example, the content type can be detected based on the selection of the video content and/or based on comparison of frames of the video content (e.g., determining the difference between consecutive frames).

At 320, upon determining that the video content is static video content, the static video content is encoded according to a first predictive coding structure. The first predictive coding structure is the special predictive coding structure depicted at 210. As part of the first predictive coding structure, at 330 a first video frame of the static content is encoded as a single key frame. In some implementations, the single key frame is an IDR frame. At 340, all of the subsequent video frames of the static content are encoded as non-reference predicted video frames that only reference the single key frame. In some implementations, all of the subsequent video frames are non-reference P frames that reference the single key frame.

At 350, the encoded static video content is transmitted to one or more other computing devices. The one or more other computing devices can received and decode, and display, the static video content.

In some implementations, upon determining that the video content is dynamic content, the example method 300 encodes the dynamic video content according to a second predictive coding structure. The second predictive coding structure is different from the first predictive coding structure. For example, the second predictive coding structure can allow predicted video frames to rely on other predicted video frames (e.g., the predicted video frames can be reference frames). The second predictive coding structure can also allow multiple key frames (e.g., I frames or IDR frames that are encoded and transmitted on a periodic basis). For example, the second predictive coding structure could be the predictive coding structure depicted at 220.

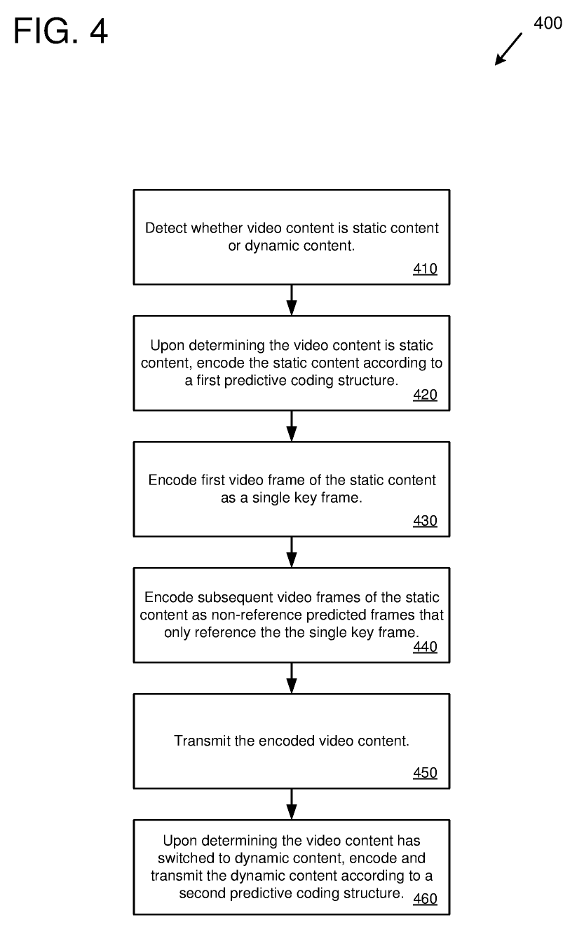

FIG. 4 is a flowchart of an example method 400 for streaming video content as a real-time video stream (e.g., as a video conference, a shared desktop, a shared video of a digital image, etc.). The example method 400 can be performed, at least in part, by a computing device, such as sending device 110. The example method 400 is performed during video streaming, such as a video call or desktop sharing session, during which video content is obtained (e.g., from a camera, from a computer desktop, from a file, etc.) and video frames are encoded and transmitted on a continuous basis for a period of time.

At 410, the type of video content is detected as either static content or dynamic content. For example, the content type can be detected based on the selection of the video content and/or based on comparison of frames of the video content (e.g., determining the difference between consecutive frames).

At 420, upon determining that the video content is static video content, the static video content is encoded according to a first predictive coding structure. The first predictive coding structure is the special predictive coding structure depicted at 210. As part of the first predictive coding structure, at 430 a first video frame of the static content is encoded as a single key frame. In some implementations, the single key frame is an IDR frame. At 440, all of the subsequent video frames of the static content are encoded as non-reference predicted video frames that only reference the single key frame. In some implementations, all of the subsequent video frames are non-reference P frames that reference the single key frame.

At 450, the encoded static video content is transmitted to one or more other computing devices as a real-time video stream. The one or more other computing devices can received and decode, and display, the static video content.

At 460, upon determining that the video content has switched from static content to dynamic content, the dynamic content is encoded and transmitted according to a second predictive coding structure. For example, the second predictive coding structure permits at least some of the predicted video frames of the dynamic content to be reference frames. For example, the second predictive coding structure could be the predictive coding structure depicted at 220.

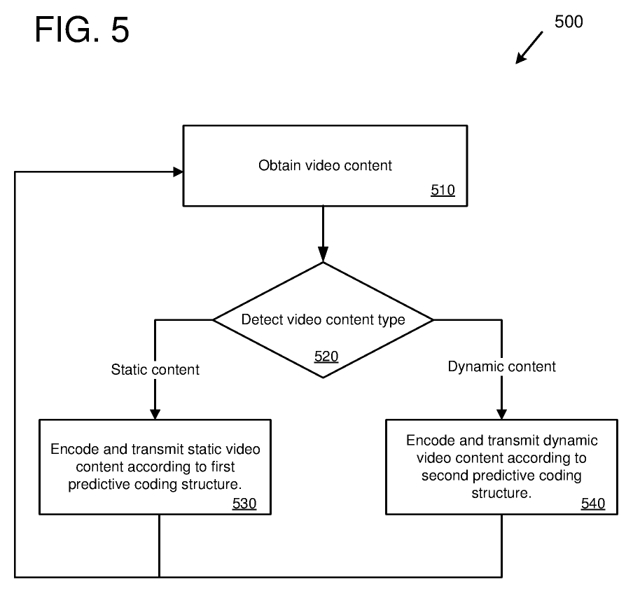

FIG. 5 is a flowchart of an example method 500 for detecting a type of video content and switching between predictive coding structures. The example method 500 can be performed, at least in part, by a computing device, such as sending device 110. The example method 500 is performed during video streaming, such as a video call or desktop sharing session, during which video content is obtained (e.g., from a camera, from a computer desktop, from a file, etc.) and video frames are encoded and transmitted on a continuous basis for a period of time.

At 510, video content is obtained. For example, the video content can be obtained from a camera, from a computer desktop, from image or picture content stored in a file, and/or from another source.

At 520, the type of video content is detected as either static content or dynamic content. For example, the content type can be detected based on the selection of the video content and/or based on comparison of frames of the video content (e.g., determining the difference between consecutive frames).

At 530, when the type of the video content is static content, the static content is encoded and transmitted according to a first predictive coding structure. The first predictive coding structure is the special predictive coding structure depicted at 210. As part of the first predictive coding structure, a first video frame of the static content is encoded as a single key frame (e.g., an IDR frame). The subsequent video frames of the static content are encoded as non-reference predicted video frames that only reference the single key frame. In some implementations, all of the subsequent video frames are non-reference P frames that reference the single key frame.

At 540, when the type of the video content is dynamic content, the dynamic content is encoded and transmitted according to a second predictive coding structure. For example, the second predictive coding structure permits at least some of the predicted video frames of the dynamic content to be reference frames and/or uses multiple key frames (e.g., encoded and transmitted on a periodic basis). For example, the second predictive coding structure could be the predictive coding structure depicted at 220.

After the static or dynamic content is encoded and transmitted, the method continues back to 510 where additional video content is obtained and detected at 520. For example, the example method 500 can be performed for each incoming video frame that is obtained at 510 (e.g., each video frame can be obtained, detected, encoded, and transmitted) or for each of a number of video frames (e.g., each group of video frames can be obtained, detected, encoded, and transmitted).

### Computing Systems

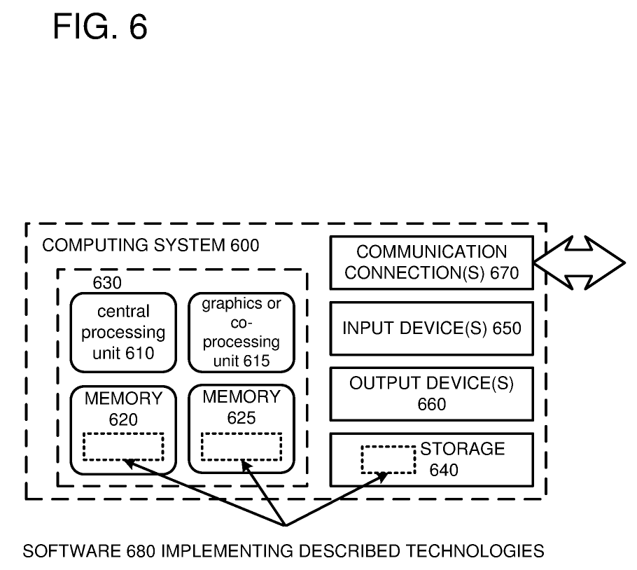

FIG. 6 depicts a generalized example of a suitable computing system 600 in which the described technologies may be implemented. The computing system 600 is not intended to suggest any limitation as to scope of use or functionality, as the technologies may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC), or any other type of processor. A processing unit can also comprise multiple processors. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more technologies described herein, in the form of computer-executable instructions suitable for execution by the processing unit(s).

A computing system may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROMs, DVDs, or any other medium which can be used to store information and which can be accessed within the computing system 600. The storage 640 stores instructions for the software 680 implementing one or more technologies described herein.

The input device(s) 650 may be a touch input device such as a keyboard, mouse, pen, or trackball, a voice input device, a scanning device, or another device that provides input to the computing system 600. For video encoding, the input device(s) 650 may be a camera, video card, TV tuner card, or similar device that accepts video input in analog or digital form, or a CD-ROM or CD-RW that reads video samples into the computing system 600. The output device(s) 660 may be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The technologies can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Mobile Device

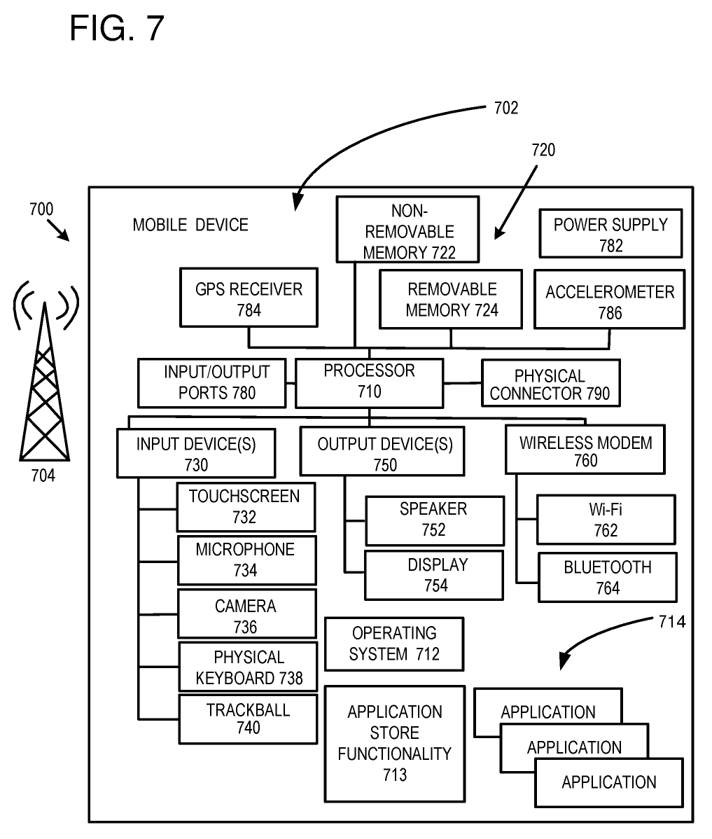

FIG. 7 is a system diagram depicting an example mobile device 700 including a variety of optional hardware and software components, shown generally at 702. Any components 702 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 704, such as a cellular, satellite, or other network.

The illustrated mobile device 700 can include a controller or processor 710 (e.g., signal processor, microprocessor, ASIC, or other control and processing logic circuitry) for performing such tasks as signal coding, data processing, input/output processing, power control, and/or other functions. An operating system 712 can control the allocation and usage of the components 702 and support for one or more application programs 714. The application programs can include common mobile computing applications (e.g., email applications, calendars, contact managers, web browsers, messaging applications), or any other computing application. Functionality 713 for accessing an application store can also be used for acquiring and updating application programs 714.

The illustrated mobile device 700 can include memory 720. Memory 720 can include non-removable memory 722 and/or removable memory 724. The non-removable memory 722 can include RAM, ROM, flash memory, a hard disk, or other well-known memory storage technologies. The removable memory 724 can include flash memory or a Subscriber Identity Module (SIM) card, which is well known in GSM communication systems, or other well-known memory storage technologies, such as “smart cards.” The memory 720 can be used for storing data and/or code for running the operating system 712 and the applications 714. Example data can include web pages, text, images, sound files, video data, or other data sets to be sent to and/or received from one or more network servers or other devices via one or more wired or wireless networks. The memory 720 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 700 can support one or more input devices 730, such as a touchscreen 732, microphone 734, camera 736, physical keyboard 738 and/or trackball 740 and one or more output devices 750, such as a speaker 752 and a display 754. Other possible output devices (not shown) can include piezoelectric or other haptic output devices. Some devices can serve more than one input/output function. For example, touchscreen 732 and display 754 can be combined in a single input/output device.

The input devices 730 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 712 or applications 714 can comprise speech-recognition software as part of a voice user interface that allows a user to operate the device 700 via voice commands. Further, the device 700 can comprise input devices and software that allows for user interaction via a user's spatial gestures, such as detecting and interpreting gestures to provide input to a gaming application.

A wireless modem 760 can be coupled to an antenna (not shown) and can support two-way communications between the processor 710 and external devices, as is well understood in the art. The modem 760 is shown generically and can include a cellular modem for communicating with the mobile communication network 704 and/or other radio-based modems (e.g., Bluetooth 764 or Wi-Fi 762). The wireless modem 760 is typically configured for communication with one or more cellular networks, such as a GSM network for data and voice communications within a single cellular network, between cellular networks, or between the mobile device and a public switched telephone network (PSTN).

The mobile device can further include at least one input/output port 780, a power supply 782, a satellite navigation system receiver 784, such as a Global Positioning System (GPS) receiver, an accelerometer 786, and/or a physical connector 790, which can be a USB port, IEEE 1394 (FireWire) port, and/or RS-232 port. The illustrated components 702 are not required or all-inclusive, as any components can be deleted and other components can be added.

Cloud-Supported Environment

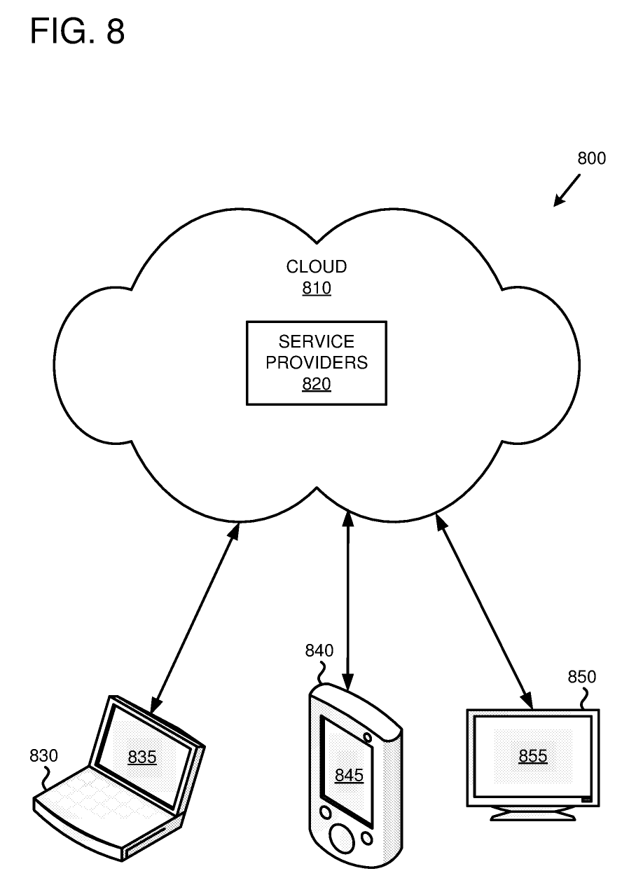

FIG. 8 illustrates a generalized example of a suitable cloud-supported environment 800 in which described embodiments, techniques, and technologies may be implemented. In the example environment 800, various types of services (e.g., computing services) are provided by a cloud 810. For example, the cloud 810 can comprise a collection of computing devices, which may be located centrally or distributed, that provide cloud-based services to various types of users and devices connected via a network such as the Internet. The implementation environment 800 can be used in different ways to accomplish computing tasks. For example, some tasks (e.g., processing user input and presenting a user interface) can be performed on local computing devices (e.g., connected devices 830, 840, 850) while other tasks (e.g., storage of data to be used in subsequent processing) can be performed in the cloud 810.

In example environment 800, the cloud 810 provides services for connected devices 830, 840, 850 with a variety of screen capabilities. Connected device 830 represents a device with a computer screen 835 (e.g., a mid-size screen). For example, connected device 830 could be a personal computer such as desktop computer, laptop, notebook, netbook, or the like. Connected device 840 represents a device with a mobile device screen 845 (e.g., a small size screen). For example, connected device 840 could be a mobile phone, smart phone, personal digital assistant, tablet computer, and the like. Connected device 850 represents a device with a large screen 855. For example, connected device 850 could be a television screen (e.g., a smart television) or another device connected to a television (e.g., a set-top box or gaming console) or the like. One or more of the connected devices 830, 840, 850 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 800. For example, the cloud 810 can provide services for one or more computers (e.g., server computers) without displays.

Services can be provided by the cloud 810 through service providers 820, or through other providers of online services (not depicted). For example, cloud services can be customized to the screen size, display capability, and/or touchscreen capability of a particular connected device (e.g., connected devices 830, 840, 850).

In example environment 800, the cloud 810 provides the technologies and solutions described herein to the various connected devices 830, 840, 850 using, at least in part, the service providers 820. For example, the service providers 820 can provide a centralized solution for various cloud-based services. The service providers 820 can manage service subscriptions for users and/or devices (e.g., for the connected devices 830, 840, 850 and/or their respective users).

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (i.e., any available computing device, including smart phones or other mobile devices that include computing hardware). Computer-readable storage media are tangible media that can be accessed within a computing environment (one or more optical media discs such as DVD or CD, volatile memory (such as DRAM or SRAM), or nonvolatile memory (such as flash memory or hard drives)). By way of example and with reference to FIG. 6, computer-readable storage media include memory 620 and 625, and storage 640. By way of example and with reference to FIG. 7, computer-readable storage media include memory and storage 720, 722, and 724. The term computer-readable storage media does not include signals and carrier waves. In addition, the term computer-readable storage media does not include communication connections, such as 670, 760, 762, and 764.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

What is claimed is:

1. A computing device comprising:
a processing unit;
memory; and
a network connection;
the computing device configured, via computer-executable instructions, to perform operations for streaming video content, the operations comprising:
detecting whether video content to be transmitted is static content or dynamic content;
upon determining that the video content is static content, encoding the static content according to a first predictive coding structure, comprising:
encoding a first video frame of the static content as a single key frame;
encoding all subsequent video frames of the static content as predicted frames, wherein the predicted frames are non-reference frames that only reference the single key frame for decoding; and
transmitting, via the network connection, the encoded first video frame and the encoded subsequent video frames of the static content as they are encoded to one or more other computing devices.

2. The computing device of claim 1 wherein detecting whether video content to be transmitted is static content or dynamic content comprises:
calculating a difference between a plurality of video frames of the video content;
when the difference between the plurality of video frames of the video content is below a threshold value, determining that the video content is static content; and
otherwise, determining that the video content is dynamic content.

3. The computing device of claim 1 the operations further comprising:
upon determining that the video content is dynamic content, encoding the dynamic content according to a second predictive coding structure in which predicted video frames of the dynamic content are permitted to be reference frames.

4. The computing device of claim 1 the operations further comprising:
upon determining that the video content is dynamic content, encoding the dynamic content according to a second predictive coding structure, comprising:
encoding a first video frame of the dynamic content as a key frame;
encoding a plurality of subsequent video frames of the dynamic content as predicted frames, wherein at least one of the predicted frames is a reference frame that is referenced by another one of the predicted frames; and
transmitting, via the network connection, the encoded first video frame and the encoded plurality of subsequent video frames of the dynamic content as they are encoded to the one or more other computing devices.

5. The computing device of claim 1 the operations further comprising:
upon determining that the video content has switched from static content to dynamic content:
encoding the dynamic content according to a second predictive coding structure in which at least some of the predicted video frames of the dynamic content are permitted to be reference frames, and in which multiple key frames are permitted.

6. The computing device of claim 5 wherein encoding of the video content switches dynamically in real-time between the first predictive coding structure when the video content is static content and the second predictive coding structure when the video content is dynamic content.

7. The computing device of claim 1 wherein the encoded first video frame and the encoded subsequent video frames are transmitted to the one or more other computing devices as a live real-time video stream.

8. The computing device of claim 1 wherein the single key frame is an instantaneous decoder refresh (IDR) frame.

9. The computing device of claim 1 wherein the static content is encoded according to the H.264 specification, and wherein all of the subsequent video frames are encoded with a nal_ref_idc syntax element value of zero.

10. A method, implemented by a computing device, for streaming video content, the method comprising:
detecting whether video content to be transmitted as a real-time video stream is static content or dynamic content;
upon determining that the video content is static content, encoding the static content, comprising:
encoding a first video frame of the static content as a single key frame;
encoding all subsequent video frames of the static content as predicted frames, wherein the predicted frames are non-reference frames that only reference the single key frame for decoding; and
transmitting the encoded first video frame and the encoded subsequent video frames of the static content to one or more other computing devices as the real-time video stream.

11. The method of claim 10 wherein detecting whether video content to be transmitted is static content or dynamic content comprises:
calculating a difference between a plurality of video frames of the video content;
when the difference between the plurality of video frames of the video content is below a threshold value, determining that the video content is static content; and
otherwise, determining that the video content is dynamic content.

12. The method of claim 10 wherein detecting whether video content to be transmitted is static content or dynamic content comprises:
calculating a difference in pixel values between video frames of the video content; and
determining whether the video content is static content or dynamic content based at least in part on the difference in the pixel values.

13. The method of claim 10 wherein detecting whether video content to be transmitted is static content or dynamic content comprises:
calculating a sum of absolute differences (SAD) value between at least portions of video frames of the video content; and
determining whether the video content is static content or dynamic content based at least in part on the SAD value.

14. The method of claim 10 further comprising:
upon determining that the video content is dynamic content, encoding the dynamic content according to a second predictive coding structure in which predicted video frames of the dynamic content are permitted to be reference frames.

15. The method of claim 10 the operations further comprising:
upon determining that the video content is dynamic content, encoding the dynamic content according to a second predictive coding structure, comprising:
encoding a first video frame of the dynamic content as a key frame;
encoding a plurality of subsequent video frames of the dynamic content as predicted frames, wherein at least one of the predicted frames is a reference frame that is referenced by another one of the predicted frames; and
transmitting, via the network connection, the encoded first video frame and the encoded plurality of subsequent video frames of the dynamic content as the real-time video stream.

16. The method of claim 10 the operations further comprising:
upon determining that the video content has switched from static content to dynamic content:
encoding the dynamic content according to a second predictive coding structure in which at least some of the predicted video frames of the dynamic content are permitted to be reference frames, and in which multiple key frames are permitted.

17. A computer-readable storage medium storing computer-executable instructions for execution on a computing device to perform operations for streaming video content, the operations comprising:
detecting whether video content to be transmitted as a real-time video stream is static content or dynamic content;
upon determining that the video content is static content, encoding the static content according to a first predictive coding structure, comprising:
encoding a first video frame of the static content as a single key frame;
encoding all subsequent video frames of the static content as predicted frames, wherein the predicted frames are non-reference frames that only reference the single key frame for decoding; and
transmitting the encoded first video frame and the encoded subsequent video frames of the static content to one or more other computing devices as the real-time video stream; and
upon determining that the video content has switched to dynamic content, encoding and transmitting the dynamic content according to a second predictive coding structure in which at least some of the predicted video frames of the dynamic content are permitted to be reference frames.

18. The computer-readable storage medium of claim 17 wherein detecting whether video content to be transmitted is static content or dynamic content comprises:
calculating a difference between a plurality of video frames of the video content;
when the difference between the plurality of video frames of the video content is below a threshold value, determining that the video content is static content; and
otherwise, determining that the video content is dynamic content.

19. The computer-readable storage medium of claim 17 wherein encoding the dynamic content according to the second predictive coding structure comprises:
encoding a first video frame of the dynamic content as a key frame;
encoding a plurality of subsequent video frames of the dynamic content as predicted frames, wherein at least one of the predicted frames is a reference frame that is referenced by another one of the predicted frames; and
transmitting the encoded first video frame and the encoded plurality of subsequent video frames of the dynamic content as the real-time video stream.

20. The computer-readable storage medium of claim 17 wherein the static content is encoded according to the H.264 specification, and wherein all of the subsequent video frames of the static content are encoded with a nal_ref_idc syntax element value of zero.
